(19) United States
(12) Patent Application Publication
(10) Pub. No.: US 2026/0299928 A1
(43) Pub. Date: Oct. 1, 2026

(54) IMAGE PROCESSING APPARATUS AND CONTROL METHOD FOR AN IMAGE PROCESSING APPARATUS

(71) Applicant: KYOCERA Document Solutions Inc., Osaka (JP)

(72) Inventor: Yoshitaka Matsuki, Osaka (JP)

(21) Appl. No.: 19/569,197

(22) Filed: Mar. 17, 2026

(30) Foreign Application Priority Data
Mar. 31, 2025 (JP) 2025-058550

(51) Int. Cl. G06F 8/65

(52) U.S. Cl. CPC G06F 8/65

(57) ABSTRACT

An image processing apparatus includes an acquisition processing unit and an update processing unit. The acquisition processing unit acquires an update program for firmware implemented in a main body. The update processing unit updates, in a case where the firmware is specific firmware that is disallowed to be unconditionally updated on the basis of the update program, the specific firmware on the basis of the update program when a specific condition is met.

### INCORPORATION BY REFERENCE

This application is based upon and claims the benefit of priority from the corresponding Japanese Patent Application No. 2025-058550 filed on Mar. 31, 2025, the entire contents of which are incorporated herein by reference.

The present disclosure relates to an image processing apparatus and a control method for an image processing apparatus.

### BACKGROUND

As a relevant technology, an information processing apparatus is known which executes notification related to update in a case where the version of firmware that a communication apparatus, such as a printer, currently has is not the latest version of the firmware. This information processing apparatus prompts the user to make an operation for updating by the notification.

### SUMMARY

An image processing apparatus according to an aspect of the present disclosure includes an acquisition processing unit and an update processing unit. The acquisition processing unit acquires an update program for firmware implemented in a main body. The update processing unit updates, in a case where the firmware is specific firmware that is disallowed to be unconditionally updated on the basis of the update program, the specific firmware on the basis of the update program when a specific condition is met.

A control method for an image processing apparatus according to another aspect of the present disclosure includes acquiring an update program for firmware implemented in a main body of the image processing apparatus. The control method for an image processing apparatus includes updating, in a case where the firmware is specific firmware that is disallowed to be unconditionally updated on the basis of the update program, the specific firmware on the basis of the update program when a specific condition is met.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any unit of this disclosure.

These and other objects, features and advantages of the present disclosure will become more apparent in light of the following detailed description of best mode embodiments thereof, as illustrated in the accompanying drawings.

### BRIEF DESCRIPTION OF FIGURES

FIG. 1 is a schematic block diagram showing a configuration of an image processing apparatus according to an embodiment.

FIG. 2 is a schematic diagram showing an outer appearance of the image processing apparatus according to the embodiment.

FIG. 3 is a schematic diagram showing a display example of a first operation unit in the image processing apparatus according to the embodiment.

FIG. 4 is a schematic diagram showing a display example of a second operation unit in the image processing apparatus according to the embodiment.

FIG. 5 is a flowchart showing an operation example of the image processing apparatus according to the embodiment.

FIG. 6 is a schematic diagram showing an example of function information used in the image processing apparatus according to the embodiment.

FIG. 7 is a schematic diagram showing a determination example of an update target using function information in the image processing apparatus according to the embodiment.

### DETAILED DESCRIPTION

Hereinafter, an embodiment of the present disclosure will be described with reference to the accompanying drawings. The following embodiment is an example embodying the present disclosure and is not intended to limit the technical scope of the present disclosure.

### Overall Configuration of Image Processing Apparatus

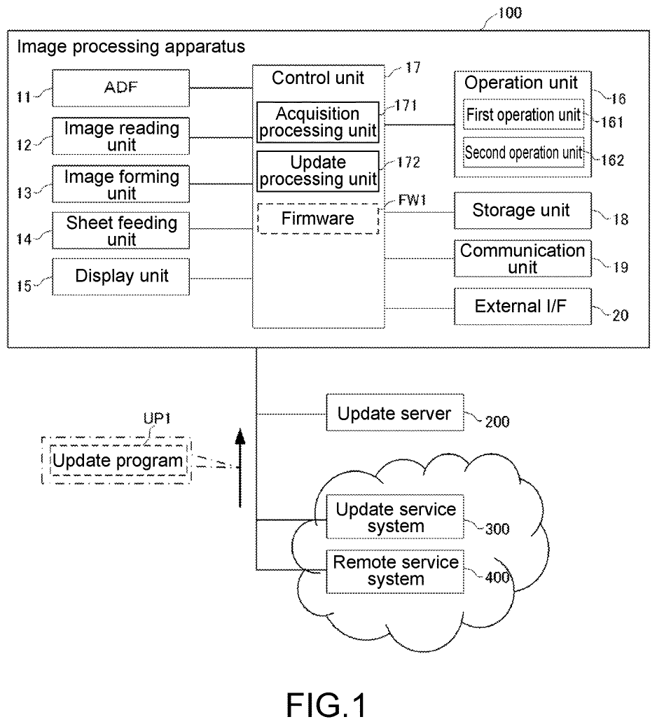

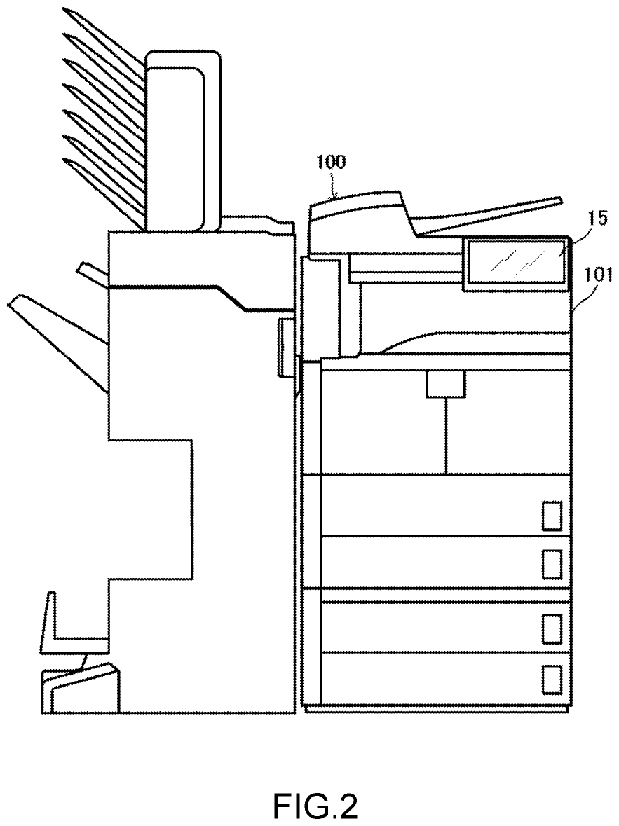

First of all, an overall configuration of an image processing apparatus 100 according to this embodiment will be described with reference to FIGS. 1 and 2.

The image processing apparatus 100 according to this embodiment is, for example, a multifunction peripheral with a plurality of functions such as a scan function that acquires image data from a document, a printing function that forms an image on the basis of the image data, a facsimile function, and a copying function. The image processing apparatus 100 only needs to have an image processing function including at least one of the function that forms an image and a function that acquires image data. The image processing apparatus 100 may be a printer, a scanner, a facsimile apparatus, or a copying machine, for example.

As shown in FIG. 1, the image processing apparatus 100 includes an ADF 11, an image reading unit 12, an image forming unit 13, a sheet feeding unit 14, a display unit 15, an operation unit 16, a control unit 17, a storage unit 18, a communication unit 19, and an external I/F 20. The ADF 11 is an automatic document conveying apparatus and is an abbreviation for an automatic document feeder. Moreover, the external I/F 20 is an abbreviation for an external interface (Interface).

In this embodiment, as shown in FIG. 2, the image processing apparatus 100 includes a main body 101. The ADF 11, the image reading unit 12, the image forming unit 13, the sheet feeding unit 14, the display unit 15, the operation unit 16, the control unit 17, the storage unit 18, the communication unit 19, and the external I/F 20 are all provided in the main body 101.

The ADF 11 conveys a document whose image is to be read by the image reading unit 12. The ADF 11 includes a document setter, a plurality of conveying rollers, document guides, and a sheet output unit, for example.

The image reading unit 12 reads an image from the document and outputs image data corresponding to the read image. The image reading unit 12 includes a document table, a light source, a plurality of mirrors, an optical lens, and a charge coupled device (CCD), for example.

The image forming unit 13 forms an image on a sheet by an electrophotographic technology on the basis of the image data output from the image reading unit 12. Moreover, the image forming unit 13 forms an image on a sheet on the basis of image data input from an information processing apparatus outside the image processing apparatus 100, such as a personal computer. The image forming unit 13 includes four image forming units corresponding to four colors of C (cyan), M (magenta), Y (yellow), and K (black), a light scanner, an intermediate transferring belt, a secondary transferring roller, and a fuser, for example. For example, the image forming unit 13 may have a configuration to form an image on a sheet by an image forming technology other than the electrophotographic technology, such as an inkjet technology.

The image forming unit 13 forms an image on a sheet with toner as a developer. In a case where the image forming unit 13 forms an image by the inkjet technology, ink (another developer example) is supplied instead of the toner. For example, the toner supplied to the image forming unit 13 includes multiple-color toners of C(cyan), M(magenta), Y(yellow), and K(black). The sheet on which the image has been formed by the image forming unit 13 is output (supplied) to an expansion device or the like for post-processing.

The sheet feeding unit 14 feeds a sheet to the image forming unit 13. The sheet feeding unit 14 includes a sheet feed cassette, a manual feed tray, a sheet conveyance path, and a plurality of conveying rollers, for example. The image forming unit 13 forms an image on the sheet fed by the sheet feeding unit 14. For example, the sheet fed by the image forming unit 13 is paper, though not limited to the paper. For example, the sheet fed by the image forming unit 13 may be a resin film.

The display unit 15 is a user interface for presenting (displaying) information to the user in the image processing apparatus 100. The display unit 15 displays various types of information in accordance with a control instruction from the control unit 17. In this embodiment, for example, the display unit 15 includes a liquid-crystal display and displays a display screen including a variety of information on the liquid-crystal display.

For example, the operation unit 16 is a user interface for receiving the user's operation on the display screen displayed on the display unit 15. For example, the operation unit 16 receives the user's various operations by outputting electrical signals according to the user's operation. In this embodiment, for example, the operation unit 16 includes switches, keys, or a numeric keypad, and a touch panel.

Moreover, the image processing apparatus 100 may include, for example, a sound output unit and a sound input unit as user interfaces in addition to or instead of the display unit 15 and the operation unit 16.

In this embodiment, the operation unit 16 includes a first operation unit 161 and a second operation unit 162. Each of the first operation unit 161 and the second operation unit 162 is realized as one function of the operation unit 16. Note that the first operation unit 161 and the second operation unit 162 may be provided in the image processing apparatus 100 as different operation units.

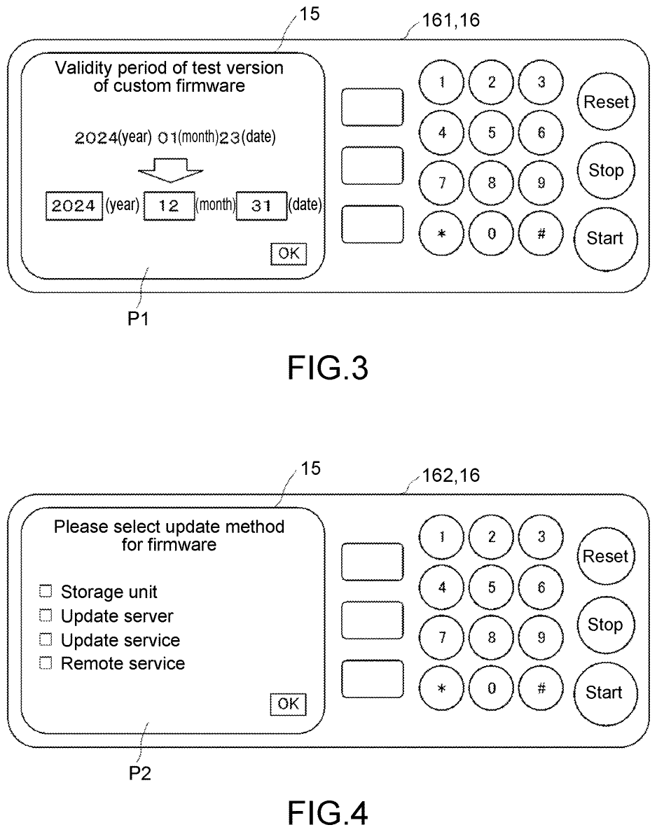

The first operation unit 161 receives an operation of setting a validity period (to be described later) of firmware FW1. Specifically, when the operation unit 16 (first operation unit 161) receives an operation of shifting to a first setting screen P1 (see FIG. 3) capable of receiving the operation of setting the validity period, the first setting screen P1 is displayed on the display unit 15. An input box or the like for entering the validity period of the firmware FW1 (here, a test version of custom firmware), which is represented as year, date, and month, is displayed on the first setting screen P1. The user makes an operation of entering a desired validity period of the firmware FW1 on the first setting screen P1. Then, the control unit 17 updates the validity period of the firmware FW1 in accordance with the operation received by the operation unit 16 (first operation unit 161).

Note that for example, the above-mentioned operation of setting the validity period may be performed by a maintenance personnel of a service provider that provides various services for the image processing apparatus. Moreover, for example, such an operation may be executable only by an authorized person of users. For example, the operation of shifting to the first setting screen P1 may be executable through for example the user's authentication with a password or biometrics authentication with fingerprint or the like.

The second operation unit 162 receives an operation of setting an update method (to be described later) of the firmware FW1. Specifically, when the operation unit 16 (second operation unit 162) receives an operation of shifting to a second setting screen P2 (see FIG. 4) capable of receiving the operation of setting the update method, the second setting screen P2 is displayed on the display unit 15. A check box or the like for selecting one update method of a plurality of (here, four) update methods is displayed on the second setting screen P2.

In the example shown in FIG. 4, the check boxes of “Storage unit” indicating an update method using the storage unit 18 and “Update server” indicating an update method using an update server 200 are displayed on the display unit 15. Moreover, in the example shown in FIG. 4, the check boxes of “Update service” indicating an update method using an update service system 300 (to be described later) and “Remote service” indicating an update method using a remote service system 400 (to be described later) are displayed on the display unit 15.

The user makes an operation of entering a desired update method on the second setting screen P2. Then, an update processing unit 172 (to be described later) updates the firmware FW1 by the update method set by the operation unit 16 (second operation unit 162) when updating the firmware FW1 on the basis of that a specific condition to be described later is met.

The control unit 17 includes a computer system with one or more processors and one or more memories as main configurations and comprehensively controls the image processing apparatus 100. In the image processing apparatus 100, the functions of the control unit 17 are realized by the one or more processors executing programs. In this embodiment, for example, the control unit 17 includes a central processing unit (CPU).

The programs may be recorded in advance in the one or more memories. Alternatively, the programs may be provided via a telecommunication line, such as the Internet. Alternatively, the programs may be provided, recorded in a non-transitory recording medium readable by the computer system, such as a memory card or optical disc. The one or more processors are constituted by one or more electronic circuits including a semiconductor integrated circuit. In addition, the computer system set forth herein includes a micro-controller with one or more processors and one or more memories. The control unit 17 may be a control unit separately provided from a main control unit that comprehensively controls the image processing apparatus 100.

The storage unit 18 prestores information including a control program and the like for causing the control unit 17 to execute various processes. In this embodiment, for example, the storage unit 18 includes one or more nonvolatile memories such as a read only memory (ROM), a hard disk drive (HDD), and a solid state disk (SSD). Moreover, for example, the storage unit 18 includes one or more volatile memories such as a random access memory (RAM).

In this embodiment, the storage unit 18 may store past firmware. The past firmware is firmware implemented in the main body 101 prior to the firmware FW1 implemented in the image processing apparatus 100. For example, the past firmware is official firmware implemented in the image processing apparatus 100 before it is customized by the maintenance personnel.

The communication unit 19 is an interface that executes data communication between the image processing apparatus 100 and an external system connected via a communication network, such as the Internet or a local area network (LAN). In this embodiment, the communication unit 19 is, as shown in FIG. 1, is configured to be capable of communicating with external systems, the update server 200, the update service system 300, and the remote service system 400. The data communication may be wired communication or may be wireless communication. Moreover, for example, the data communication may be wireless communication according to short-range wireless communication standards, such as Near Field Communication (NFC) (registered trademark) or Bluetooth (registered trademark).

The update server 200 stores an update program UP1 for updating the firmware FW1 used to control the main body 101 of the image processing apparatus 100. For example, the update server 200 is constituted by a server apparatus connected to the same network (e.g., an intranet or LAN) as the image processing apparatus 100. The update server 200 delivers the update program UP1 to the image processing apparatus 100. That is, the image processing apparatus 100 is configured to be capable of receiving the update program UP1 from the update server 200 by communicating with the update server 200 via the communication unit 19.

The update service system 300 is a system that provides the update program UP1 to the user of the image processing apparatus 100. For example, the update service system 300 includes a server apparatus connected to the Internet. As in the update server 200, the update service system 300 stores the update program UP1 and delivers the update program UP1 to the image processing apparatus 100. That is, the image processing apparatus 100 is configured to be capable of receiving the update program UP1 from the update service system 300 by communicating with the update service system 300 via the communication unit 19.

The remote service system 400 is a system operated by the service provider and is a system that remotely provides the user of the image processing apparatus 100 with various services without visiting the location where the image processing apparatus 100 is installed. The services provided by the remote service system 400 to the user include a service of updating the firmware FW1. For example, the remote service system 400 includes a server apparatus connected to the Internet. As in the update server 200, the remote service system 400 stores the update program UP1 and delivers the update program UP1 to the image processing apparatus 100. That is, the image processing apparatus 100 is configured to be capable of receiving the update program UP1 from the remote service system 400 by communicating with the remote service system 400 via the communication unit 19.

The external I/F 20 is an interface that includes a port to which an external memory or external apparatus is connected and executes data communication with the external memory or external apparatus connected to the port. In this embodiment, for example, the external memory includes a universal serial bus (USB) memory. Moreover, for example, the external apparatus includes a device compatible to a USB mass storage.

By the way, as a relevant technology, an information processing apparatus is known which executes notification related to update in a case where the version of firmware that a communication apparatus, such as a printer, currently has is not the latest version of the firmware. This information processing apparatus prompts the user to make an operation for updating by the notification.

In the image processing apparatus as shown in such a relevant technology, custom firmware is used in some cases. For example, the custom firmware has been edited by the maintenance personnel of the image processing apparatus, such that the custom firmware cannot be unconditionally updated to official firmware. Therefore, there is a problem that the degree of freedom of updating the firmware is insufficient because it is difficult to update the custom firmware to the official firmware until the maintenance personnel performs an update task.

In this regard, in this embodiment, the processing executed by the control unit 17 of the image processing apparatus 100 to be described below realizes the image processing apparatus 100 that can improve the degree of freedom of updating the firmware and a control method for the image processing apparatus 100.

### Configuration of Control Unit

Hereinafter, each function part included in the control unit 17 will be described in more detail with reference to FIG. 1. The control unit 17 includes an acquisition processing unit 171 and the update processing unit 172. That is, the image processing apparatus 100 includes the acquisition processing unit 171 and the update processing unit 172 as functions of the control unit 17.

In addition, the control unit 17 implements the firmware FW1. The “firmware” set forth herein means software for controlling the computer system (control unit 17) incorporated in the main body 101 of the image processing apparatus 100, the software being incorporated in the main body 101 in a state in which the software is written in advance in an integrated circuit, such as a ROM. The firmware FW1 has a function of performing basic control on the main body 101 with an image processing function.

The acquisition processing unit 171 executes acquisition processing of acquiring the update program UP1. An update program UP1 is a computer program used for updating the firmware FW1 implemented in the main body 101. In this embodiment, by the communication unit 19 communicating with the external system via the communication network, such as the Internet or LAN, the acquisition processing unit 171 downloads the update program UP1 from the external system and acquires the update program UP1. That is, the acquisition processing unit 171 acquires the update program UP1 from the external system by downloading.

In this embodiment, for example, in a case where the operation unit 16 has received the user's operation to start the update of the firmware FW1, the acquisition processing unit 171 executes the acquisition processing. Note that the acquisition processing unit 171 may regularly execute the acquisition processing irrespective of whether or not the operation has been received. In the acquisition processing, the acquisition processing unit 171 inquires the external system that is any one of the update server 200, the update service system 300, or the remote service system 400 about whether or not there is any available firmware.

For example, the “available firmware” set forth herein can include the latest official firmware at the time of inquiry. The official firmware is firmware provided by a manufacturer of the image processing apparatus 100. Moreover, for example, the “available firmware” can include past official firmware implemented in the image processing apparatus 100 prior to the firmware FW1 implemented in the image processing apparatus 100.

Then, the acquisition processing unit 171 acquires from the external system the update program UP1 used for updating the firmware FW1 implemented in the image processing apparatus 100 to the available firmware in a case where there is available firmware. That is, the acquisition processing unit 171 acquires the update program UP1 from the external system by downloading. On the other hand, the acquisition processing unit 171 terminates the acquisition processing in a case where there is no available firmware.

In a case where the firmware FW1 is specific firmware, the update processing unit 172 executes the update processing of updating the specific firmware on the basis of the update program UP1 when the specific condition to be described later is met. Moreover, in a case where the firmware FW1 is not specific firmware, the update processing unit 172 executes the update processing of updating the firmware FW1 on the basis of the update program UP1.

The “specific firmware” set forth herein is firmware that cannot be unconditionally updated on the basis of the update program UP1. Specifically, the “specific firmware” is the custom firmware. Moreover, the firmware that is not the “specific firmware” is the official firmware.

The “custom firmware” set forth herein is firmware other than the official firmware provided by the manufacturer of the image processing apparatus 100, the firmware being edited by the maintenance personnel of the service provider that provides the various services to the image processing apparatus 100. The “custom firmware” includes a test version of the firmware obtained by customizing the official firmware for investigating a problem caused in the image processing apparatus 100. Moreover, the “custom firmware” includes an evaluation version of the firmware obtained by applying a measure for overcoming the problem and customizing the official firmware for checking validity of this measure. Hereinafter, the investigation of the problem will be referred to as “test” and the check of the validity of the measure will be referred to as “evaluation.”

Moreover, even in a case where the problem does not exist, firmware obtained by customizing the official firmware to have a unique function specialized to the user is also included in the “custom firmware.” For example, the “unique function” set forth herein can include a function that cannot be realized by the official firmware, which is obtained by customizing some functions that the official firmware has. Moreover, for example, the “unique function” can include a new function that the official firmware does not originally have.

First of all, the update processing unit 172 executes determination processing of determining whether or not the firmware FW1 implemented in the main body 101 is the same type as the acquired update program UP1. In other words, the update processing unit 172 executes the determination processing of determining whether or not the firmware FW1 is the specific firmware. For example, the “type” set forth herein includes a provider of the software, such as the firmware FW1 and the update program UP1. For example, in a case where the firmware FW1 is the official firmware provided by the manufacturer of the image processing apparatus 100, the provider of the firmware FW1 is the manufacturer. Moreover, for example, in a case where the firmware FW1 is the custom firmware customized by the maintenance personnel of the service provider that provides the various services to the user of the image processing apparatus 100, the provider of the firmware FW1 is the maintenance personnel.

For example, in a case where the firmware FW1 and the update program UP1 are both the official firmware, the update processing unit 172 determines that the type of the firmware FW1 is the same as the type of the update program UP1. That is, the update processing unit 172 determines that the firmware FW1 is not the specific firmware. On the other hand, in a case where the firmware FW1 is the custom firmware and the update program UP1 is the official firmware, the update processing unit 172 determines that the type of the firmware FW1 and the type of the update program UP1 are different from each other. That is, the update processing unit 172 determines that the firmware FW1 is the specific firmware.

Note that in a case where there is available firmware, the acquisition processing unit 171 may acquire from the external system only data indicating the type of the update program UP1, not complete data of the update program UP1. In this case, the update processing unit 172 refers to the acquired data indicating the type of the update program UP1 and executes the determination processing. In this case, the amount of data that the update processing unit 172 should acquire when executing the determination processing can be small. Therefore, the time necessary for the determination processing can be easily reduced.

Then, in either one of the two cases, the update processing unit 172 executes update processing of updating the firmware FW1 implemented in the image processing apparatus 100 on the basis of the update program UP1. That is, the update processing unit 172 executes the update processing in a case where the firmware FW1 and the update program UP1 have the same type as a result of the determination processing, that is, in a case where the firmware FW1 is not the specific firmware. Moreover, the update processing unit 172 executes the update processing in a case where the firmware FW1 and the update program UP1 are of different types as a result of the determination processing, that is, in a case where the firmware FW1 is the specific firmware and the specific condition is met. Note that the update program UP1 used by the update processing unit 172 for updating may be deleted (erased) after the update is completed.

The “specific condition” set forth herein means a condition under which the task of updating the firmware FW1 on the basis of the update program UP1 does not have to be performed by the maintenance personnel who customized the firmware FW1.

Here, in a case of updating the firmware FW1 (custom firmware) to the official firmware on the basis of the update program UP1, the maintenance personnel who customized the custom firmware basically performs the update task. That is, the custom firmware is used for the test or evaluation as described above.

Therefore, the above-mentioned problem can occur again if the user updates the custom firmware to the official firmware when the custom firmware is still necessary. Therefore, the update task from the custom firmware to the official firmware is performed after the maintenance personnel checks that such a problem is overcome, that is, the custom firmware is unnecessary.

Moreover, also in a case where the custom firmware is the firmware customized to have a unique function specialized to the user, the maintenance personnel who customized the custom firmware basically performs the update task. It is because if the user updates the custom firmware to the official firmware when the official firmware does not have the unique function, the user cannot use the unique function. Therefore, the update task from the custom firmware to the official firmware is performed after the maintenance personnel checks that the official firmware has such a unique function, that is, the custom firmware is unnecessary.

In contrast, in this embodiment, in a case where the specific condition is met, that is, in a case where it is acceptable for the maintenance personnel not to perform the update task, the update processing unit 172 is capable of executing the update processing without the maintenance personnel.

In this embodiment, the specific condition can include that the validity period of the firmware FW1 (specific firmware) has expired. Here, in a case where the maintenance personnel customizes the firmware FW1, the validity period may be set. The validity period represents the period in which the test or evaluation with the firmware FW1 is performed. Therefore, the expiration of the validity period represents that the test or evaluation with the firmware FW1 is completed. That is, in a case where the validity period has expired, it is acceptable for the maintenance personnel not to perform the update task.

Specifically, the specific condition is the above-mentioned condition, the update processing unit 172 executes the update processing in a case where the firmware FW1 is the specific firmware, but the validity period of the firmware FW1 has expired. On the other hand, in a case where the validity period has expired, the update processing unit 172 does not execute the update processing because the specific condition is not met.

In this embodiment, the user is able to set a desired validity period by setting the validity period through the above-mentioned operation unit 16 (first operation unit 161). For example, the user is able to set the validity period to be longer when the user considers that the period in which the test or evaluation is performed is short. Accordingly, it is possible to prevent the firmware FW1 from being updated automatically against the user's intent until the set validity period expires.

Moreover, in this embodiment, the specific condition can include that the update program UP1 has the function that the firmware FW1 (specific firmware) has. Here, in a case where the maintenance personnel customizes the firmware FW1, the unique function specialized to the user may be included in the firmware FW1. Then, this unique function may be adopted for the official firmware. Therefore, in a case where the official firmware (update program UP1) has the unique function that the custom firmware (firmware FW1) has, it is acceptable for the maintenance personnel not to perform the update task.

In this embodiment, the update processing unit 172 acquires the function information from the external system (the update server 200, the update service system 300, or the remote service system 400) and determines whether or not the specific condition is met on the basis of the function information. The specific condition here is that the update program UP1 has the function that the firmware FW1 has. The “function information” set forth herein is information indicating the function that the update program UP1 has.

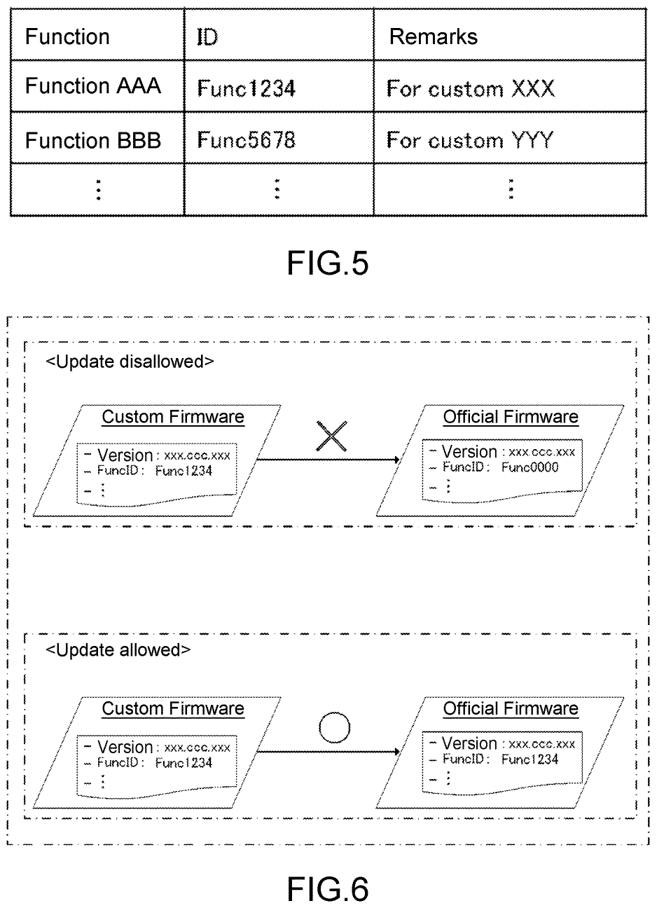

FIG. 5 shows a specific example of the function information. As shown in FIG. 5, the function information includes a function name (“function” in FIG. 5), an identifier (“ID” in FIG. 5) for identifying the function, and an additional description (“Remarks” in FIG. 5) of the function as data. For example, regarding the function whose name is “function AAA,” the identifier is “Func1234” and the additional description is “For Custom XXX.” “For Custom XXX” indicates that it is a function obtained by customizing the official firmware in the version “XXX. XXX. XXX.”

Specifically, if the specific condition is the above-mentioned condition, the update processing unit 172 executes the update processing in a case where the firmware FW1 is the specific firmware and the update program UP1 has the function that the firmware FW1 has. On the other hand, in a case where the update program UP1 does not have the function that the firmware FW1 has, the update processing unit 172 does not execute the update processing because the specific condition is not met.

FIG. 6 shows a specific example of the determination processing as to whether or not the specific condition is met by the update processing unit 172. In FIG. 6, “Custom Firmware” represents the firmware FW1 implemented in the image processing apparatus 100 (specific firmware) and “Official Firmware” represents the update program UP1. Note that in the example shown in FIG. 6, it is assumed that both the firmware FW1 and the update program UP1 have functions other than a function with the identifier of “Func1234.”

In the example shown in <Update disallowed>in FIG. 6, the firmware FW1 has the function with the identifier of “Func1234.” On the other hand, the update program UP1 does not have the function with the identifier of “Func1234.” Therefore, the update processing unit 172 determines that the specific condition is not met. On the other hand, in the example shown in <Update allowed>in FIG. 6, the firmware FW1 and the update program UP1 both have the function with the identifier of “Func1234.” Therefore, the update processing unit 172 determines that the specific condition is met.

In this embodiment, the update processing unit 172 adopts only either one of the above-mentioned two conditions as a specific condition. Note that the update processing unit 172 may adopt both the two conditions as specific conditions. For example, the update processing unit 172 may determine whether or not to execute the update processing as described below in a case where the firmware FW1 is the specific firmware.

That is, the update processing unit 172 executes the update processing in a case where the validity period of the firmware FW1 has expired and the update program UP1 has the function that the firmware FW1 has. On the other hand, the update processing unit 172 does not execute the update processing in a case where either that the validity period of the firmware FW1 has expired or that the update program UP1 has the function that the firmware FW1 has is not met.

In this embodiment, the update processing unit 172 executes the update processing of updating the firmware FW1 by the update method shown in any one of first to fourth update examples described below. Moreover, in this embodiment, the user is able to update the firmware FW1 by a desired update method by selecting an update method through the above-mentioned operation unit 16 (second operation unit 162).

### First Update Example

The first update example is an update example in a case where the storage unit 18 stores past firmware. In the first update example, the update processing unit 172 reads out the past firmware stored in the storage unit 18 and updates the firmware FW1 by using the past firmware as the update program UP1. That is, in the first update example, when the specific condition is met, the update processing unit 172 updates the firmware FW1 by using the past firmware implemented in the image processing apparatus 100 before the maintenance personnel customizes it, as the update program UP1. Accordingly, in the first update example, the firmware implemented in the image processing apparatus 100 is returned to the firmware before the maintenance personnel customizes it.

Specifically, in the first update example, when the maintenance personnel customizes the firmware, the maintenance personnel makes an operation of storing the firmware before it is customized, that is, the past firmware in the storage unit 18. Note that when the firmware is customized, the control unit 17 may execute the processing of storing the past firmware in the storage unit 18.

When then executing the update processing of updating the firmware FW1, the update processing unit 172 executes processing of checking whether or not the past firmware is stored in the storage unit 18. In a case where the past firmware is then stored in the storage unit 18, the update processing unit 172 reads out the past firmware and updates the firmware FW1 by using the past firmware as the update program UP1.

Note that in a case where the past firmware is not stored in the storage unit 18, the update processing unit 172 may update the firmware FW1 in accordance with any one of the second to fourth update examples described below.

Note that in the first update example, the acquisition processing unit 171 does not need to inquire the external system about whether or not there is any available firmware when executing the acquisition processing. It is because in a case where the past firmware is stored in the storage unit 18, the past firmware is equivalent to the available firmware. That is, in the first update example, the acquisition processing unit 171 executes the acquisition processing by reading out the past firmware from the storage unit 18.

### Second Update Example

The second update example is an update example in a case where the update server 200 is the external system. In the second update example, the update processing unit 172 updates the firmware FW1 on the basis of the update program UP1 acquired from the update server 200 by the acquisition processing unit 171.

In the second update example, the update server 200 is connected to the same network as the image processing apparatus 100, such as an intranet or LAN. Therefore, in the second update example, even if the image processing apparatus 100 is not connected to the Internet, it is possible to acquire the update program UP1 and update the firmware FW1.

### Third Update Example

The third update example is an update example in a case where the update service system 300 is the external system. In the third update example, the update processing unit 172 updates the firmware FW1 on the basis of the update program UP1 acquired from the update service system 300 by the acquisition processing unit 171.

In the third update example, the update service system 300 is connected to the Internet. Then, the update service system 300 typically stores the latest update program UP1. Therefore, in the third update example, it is easy to acquire the latest update program UP1 and update the firmware FW1.

### Fourth Update Example

The fourth update example is an update example in a case where the remote service system 400 is the external system. In the fourth update example, the update processing unit 172 updates the firmware FW1 on the basis of the update program UP1 acquired from the remote service system 400 by the acquisition processing unit 171.

In the fourth update example, the remote service system 400 is connected to the Internet. Then, the remote service system 400 typically stores the latest update program UP1. Therefore, in the fourth update example, it is easy to acquire the latest update program UP1 and update the firmware FW1. Moreover, in the fourth update example, the user is also able to perform the update task of the firmware FW1 while receiving advice from the operator of the remote service system 400.

### Operation Example of Image Processing Apparatus

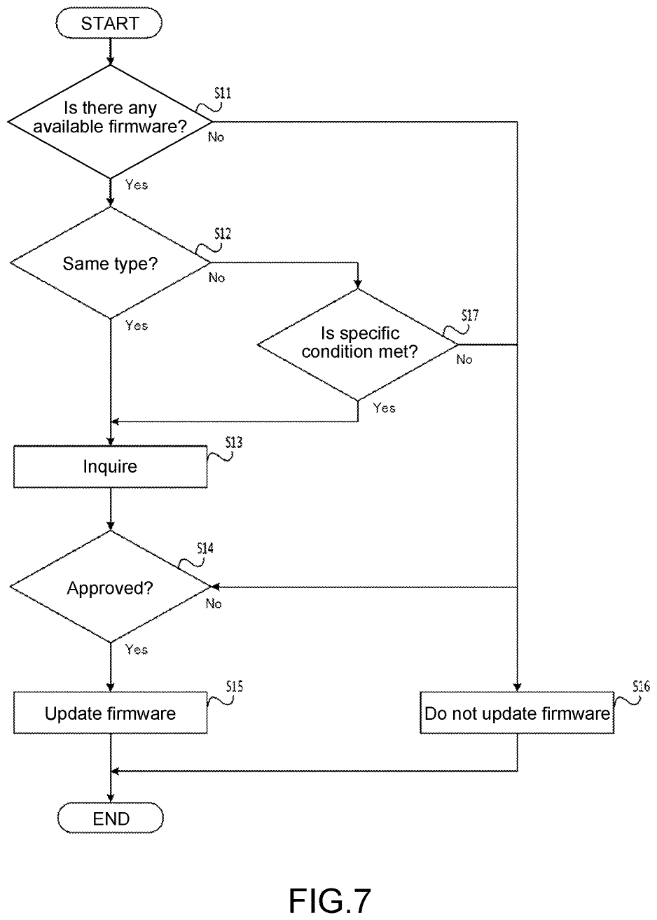

Hereinafter, an example of the procedure of the processing executed by the image processing apparatus 100 and an example of the control method for the image processing apparatus 100 according to this embodiment will be described with reference to FIG. 7. Here, Steps S11, S12, ... represent the numbers of the processing procedure (steps) executed by the image processing apparatus 100. For example, this processing is started by the operation unit 16 receiving the user's operation to start the update of the firmware FW1. Note that this processing may be regularly started irrespective of whether or not the user's operation is received.

### Step S11

The acquisition processing unit 171 of the image processing apparatus 100 executes the acquisition processing. First of all, the acquisition processing unit 171 inquires the external system about whether or not there is any available firmware. In a case where there is available firmware as a result of the inquiry (Step S11: Yes), the acquisition processing unit 171 acquires the update program UP1. Here, the acquisition processing unit 171 acquires the update program UP1 from the external system by downloading. The image processing apparatus 100 then executes Step S12. On the other hand, in a case where there is no available firmware (Step S11: No), the acquisition processing unit 171 terminates the acquisition processing.

### Step S12

The update processing unit 172 of the image processing apparatus 100 compares the type of the firmware FW1 with the type of the update program UP1, thereby determining whether or not those types are the same type. That is, the update processing unit 172 determines whether or not the firmware FW1 is the specific firmware. In a case where those types are the same type, that is, in a case where the firmware FW1 is not the specific firmware (Step S12: Yes), the update processing unit 172 executes Step S13. On the other hand, in a case where those types are different types, that is, in a case where the firmware FW1 is the specific firmware (Step S12: No), the image processing apparatus 100 executes Step S16.

### Step S13

The update processing unit 172 inquires the user about whether or not to update the firmware FW1 before updating the firmware FW1. For example, the update processing unit 172 inquires the user by displaying the message, for example, “the firmware can be updated, will you update the firmware?” on the display unit 15. Note that the inquiry to the user may be made via voice. Then, the operation unit 16 receives an input operation as to whether or not to approve the update of the firmware FW1 by the user.

step S14

In a case where the user approves the update of the firmware FW1 (Step S14: Yes), the update processing unit 172 executes Step S15. On the other hand, in a case where the user does not approve the update of the firmware FW1 (S14: No), the image processing apparatus 100 executes Step S16.

### Step S15

The update processing unit 172 executes the update processing of updating the firmware FW1 on the basis of the acquired update program UP1. For example, in a case where the firmware FW1 is the custom firmware in the test version or evaluation version and the update program UP1 is the latest official firmware, this custom firmware is updated to the latest official firmware.

### Step S16

The update processing unit 172 does not execute the update processing. Therefore, the firmware FW1 implemented in the image processing apparatus 100 is maintained. Note that the acquired update program UP1 may be deleted (erased) or may be stored in the storage unit 18.

### Step S17

The update processing unit 172 determines whether or not the specific condition is met. For example, the specific condition is that the validity period of the firmware FW1 has expired. Moreover, for example, the specific condition is that the update program UP1 has the function that the firmware FW1 has. In a case where the specific condition is met (S17: Yes), the update processing unit 172 executes Step S13. On the other hand, in a case where the specific condition is not met (S17: No), the image processing apparatus 100 executes Step S16.

Note that in the above-mentioned processing, the update processing unit 172 may update the firmware FW1 without any approval by the user. In this case, Steps S13 and S14 are unnecessary.

Moreover, the above-mentioned procedure is merely an example, and the order of processes shown in the flowchart in FIG. 7 may be changed as appropriate.

As described above, the image processing apparatus 100 according to this embodiment updates the firmware FW1 on the basis of the update program UP1 in a case where the firmware FW1 is the specific firmware, but the specific condition is met. Therefore, the image processing apparatus 100 according to this embodiment is capable of executing the update processing without the maintenance personnel who customized the custom firmware even in a case where the firmware FW1 implemented in the image processing apparatus 100 is the custom firmware. Therefore, with the image processing apparatus 100 according to this embodiment, the user is able to easily perform the update task of the firmware FW1, which can improve the degree of freedom of updating of the firmware FW1, as compared to a configuration in which the firmware FW1 cannot be updated without the maintenance personnel.

### Modified Examples

In this embodiment, the plurality of components included in the image processing apparatus 100 may be distributed and provided in a plurality of casings. For example, the acquisition processing unit 171 and the update processing unit 172 may be respectively separately provided.

Moreover, the display unit 15 is not limited to the liquid-crystal display. For example, instead of or in addition to an organic EL display, a display device, such as electronic paper or projector, may be included.

Moreover, the means by which the acquisition processing unit 171 acquires the update program UP1 is not limited to downloading from the external system, and it may be downloaded from another apparatus or it may be read from a recording medium, such as a USB memory storing the update program UP1.

### Notes of Disclosure

The outline of the disclosure extracted from the above-mentioned embodiments will be given below. Note that the configurations and processing functions described in the following notes can be arbitrarily selected and combined.

### Note 1

An image processing apparatus, including:
an acquisition processing unit that acquires an update program for firmware implemented in a main body; and
an update processing unit that updates, in a case where the firmware is specific firmware that is disallowed to be unconditionally updated on the basis of the update program, the specific firmware on the basis of the update program when a specific condition is met.
   note 2

The image processing apparatus according to Note 1, in which
the specific condition includes that a validity period of the specific firmware has expired.

### Note 3

The image processing apparatus according to Note 2, further including a first operation unit that receives an operation of setting the validity period.

### Note 4

The image processing apparatus according to any one of Notes 1 to 3, in which
the specific condition includes that the update program has a function that the specific firmware has.

### Note 5

The image processing apparatus according to Note 4, in which
the update processing unit acquires from an external system function information indicating the function that the update program has, and determines whether or not the specific condition is met on the basis of the function information.

### Note 6

The image processing apparatus according to any one of Notes 1 to 5, further including
a storage unit that stores past firmware implemented in the main body prior to the specific firmware, in which
the update processing unit updates the specific firmware by using the past firmware as the update program when the specific condition is met.

### Note 7

The image processing apparatus according to any one of Notes 1 to 6, further including
a second operation unit that receives an operation of setting an update method for the firmware, in which
the update processing unit updates the specific firmware by the set update method when the specific condition is met.

### Note 8

A control method for an image processing apparatus, including:
acquiring an update program for firmware implemented in a main body of the image processing apparatus; and
updating, in a case where the firmware is specific firmware that is disallowed to be unconditionally updated on the basis of the update program, the specific firmware on the basis of the update program when a specific condition is met.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

It should be understood by those skilled in the art that various modifications, combinations, sub-combinations and alterations may occur depending on design requirements and other factors insofar as they are within the scope of the appended claims or the equivalents thereof.

1. An image processing apparatus, comprising:
an acquisition processing unit that acquires an update program for firmware implemented in a main body; and
an update processing unit that updates, in a case where the firmware is specific firmware that is disallowed to be unconditionally updated on a basis of the update program, the specific firmware on a basis of the update program when a specific condition is met.

2. The image processing apparatus according to claim 1, wherein
the specific condition includes that a validity period of the specific firmware has expired.

3. The image processing apparatus according to claim 2, further comprising a first operation unit that receives an operation of setting the validity period.

4. The image processing apparatus according to claim 1, wherein
the specific condition includes that the update program has a function that the specific firmware has.

5. The image processing apparatus according to claim 4, wherein
the update processing unit acquires from an external system function information indicating the function that the update program has, and determines whether or not the specific condition is met on a basis of the function information.

6. The image processing apparatus according to claim 1, further comprising
a storage unit that stores past firmware implemented in the main body prior to the specific firmware, wherein
the update processing unit updates the specific firmware by using the past firmware as the update program when the specific condition is met.

7. The image processing apparatus according to claim 1, further comprising
a second operation unit that receives an operation of setting an update method for the firmware, wherein
the update processing unit updates the specific firmware by the set update method when the specific condition is met.

8. A control method for an image processing apparatus, comprising:
acquiring an update program for firmware implemented in a main body of the image processing apparatus; and
updating, in a case where the firmware is specific firmware that is disallowed to be unconditionally updated on a basis of the update program, the specific firmware on a basis of the update program when a specific condition is met.
